(19) United States
(12) Patent Application Publication
(10) Pub. No.: US 2014/0306776 A1
(43) Pub. Date: Oct. 16, 2014

(54) PLANAR RF CROSSOVER STRUCTURE WITH BROADBAND CHARACTERISTIC

(71) Applicant: Electronics and Telecommunications Research Institute, Daejeon (KR)

(72) Inventors: Soon Young EOM, Daejeon (KR); Joung Myoun KIM, Daejeon (KR); JeongHo JU, Daejeon (KR); Myung Sun SONG, Daejeon (KR); Jae Ick CHOI, Daejeon (KR)

(73) Assignee: Electronics and Telecommunications Research Institute, Daejeon (KR)

(21) Appl. No.: 14/024,157

(22) Filed: Sep. 11, 2013

(30) Foreign Application Priority Data
Apr. 16, 2013 (KR) 10-2013-0041519

(51) Int. Cl. H01P 5/00; H01P 3/08

(52) U.S. Cl. CPC H01P 3/003
USPC 333/1; 333/246

(57) ABSTRACT

An RF crossover structure includes a first and second independent transmission lines formed to cross with each other on a same surface of a dielectric substrate; first via-holes connected to the second transmission line so that the second transmission line is connected to a back surface from a front surface of the dielectric substrate and is connected again to the front surface of the dielectric substrate out of a crossing region at which the first and the second transmission lines are crossed. Further, the RF crossover structure includes CPW (Coplanar Waveguide) transmission lines used for a ground plane to improve a signal transmission property at the crossing region.

### CROSS-REFERENCE TO RELATED APPLICATION(S)

The present invention claims priority of Korean Patent Application No. 10-2013-0041519, filed on Apr. 16, 2013, which is incorporated herein by reference.

### FIELD OF THE INVENTION

The present invention relates to a compact RF crossover structure with broadband characteristic and high isolation, and more particularly, to a planar RF crossover structure in which two orthogonal independent first and second microstrip transmission lines are formed on the same surface to cross over each other, and the crossing region of the first and the second microstrip transmission lines are formed on different surfaces, wherein a first microstrip transmission line extends from a first (top) surface, and a second microstrip transmission line runs to a second (bottom) surface from the first surface through a via-hole connection structure and is out of the crossing region to extend to the first surface again through a via-hole connection structure, and a structure of CPW (Coplanar Waveguide) transmission line is formed on the crossing region to keep the same characteristic impedance.

### BACKGROUND OF THE INVENTION

Typically, an important feature of the microstrip structure is that it is able to integrate complex circuits within a planar structure. However, as the complexity of a microwave circuit is increased, there may occur a problem that independent transmission lines are crossed, which leads to degradation of circuit performance and will disturb the optimization of circuit size.

RF crossover components provide the ability to allow two independent transmission lines to cross within permissible isolation performance and thus make it possible to simply implement complex microstrip circuits. In particular, the RF crossover is often used in a multi-beam forming circuitry (used in the Butler matrix structure) and a microwave system that requires complex connections or wirings such as microwave switch matrixes.

As shown in FIGS. 1A, 1B and 1C, conventional RF crossover structures include wire bonding or air bridge structure, a structure with an impedance compensation circuit around crossed transmission lines, a cascaded 90° hybrid coupler structure and the like.

The wire bonding structure as shown in FIG. 1A is the simplest RF crossover structure. This wire bonding structure suffers from a process in which a wire is connected in the air while maintaining a certain height, which affects input/output impedance matching and an isolation characteristic. That is, if a height from the bottom increases, the isolation performance is improved, but the impedance matching characteristic becomes degraded. Accordingly, these above characteristics need to be considered in a mutual compromise. Such a simple RF crossover structure has a disadvantage to require an additional processing such as wire bonding after a PCB fabrication. Therefore, it is often used in an MMIC process.

FIG. 1B shows an RF crossover with an impedance compensation circuit around crossed transmission lines. The width of crossed transmission lines is reduced in order to improve a mutual isolation characteristic, and additional circuitries are disposed around the transmission lines in order to compensate for the impedance mismatching characteristic due to the reduced width. This structure has drawbacks such as an increased size owing to the additional circuitries and a narrow band characteristic.

Further, as shown in FIG. 1C, a cascaded 90° hybrid coupler structure has a configuration in which a pair of 90° hybrid couplers is connected in series to allow crossing independent two transmission lines with each other. However, this structure has a disadvantage of an increase in a circuit size, an increase of an insertion loss due to an increased length of the transmission lines, and a narrow-band characteristic owing to the electrical characteristics of the cascaded 90° hybrid structure.

### SUMMARY OF THE INVENTION

In view of the above, the present invention provides a planar RF crossover structure in which two independent first and second microstrip transmission lines are formed on the same surface to cross with each other, and the crossing region of the first and the second microstrip transmission lines are formed on different surfaces, wherein a first microstrip transmission line extends from a first surface (top), and a second microstrip transmission line runs to a second surface (bottom) from the first surface through a via-hole connection structure and is out of the crossing region to extend to the first surface again through the via-hole connection structure, and a structure of CPW transmission line is formed on the crossing region to achieve a signal transfer property.

In accordance with an embodiment of the present invention, there is provided an RF crossover structure including: a first and second independent transmission lines formed to cross with each other on a same surface of a dielectric substrate; first via-holes connected to the second transmission line so that the second transmission line is connected to a back surface from a front surface of the dielectric substrate and is connected again to the front surface of the dielectric substrate out of a crossing region at which the first and the second transmission lines are crossed; and CPW (Coplanar Waveguide) transmission lines used for a ground plane to keep the same characteristic impedance at the crossing region.

Further, the RF crossover structure may further comprise second via-holes that connect the CPW transmission line to a ground plane on the back surface of the dielectric substrate. Further, the CPW transmission lines may be configured to compensate the signal transmission property due to a mutual signal coupling at the crossing region between the first and second transmission lines.

Further, the signal transmission property may comprise an input/out impedance matching characteristic or change in impedance.

Further, the CPW transmission lines may be configured to have the same impedance characteristic as the input/output characteristic impedances in order to isolate the second transmission line that is extended to the back surface of the dielectric substrate through the structure of the via-holes from the ground plane.

Further, the RF crossover structure may further comprise a slot-loop formed in the form of a rectangle in the vicinity of the second transmission line on the back surface of the dielectric substrate in order to improve a signal transmission property. Further, the first and second transmission lines may have a conductive area of which a portion is eliminated in a certain form so that a signal coupling region is set to be a predetermined area and an amount of a mutual signal coupling of the first and second transmission lines that are perpendicular to each other on different surfaces of the dielectric substrate is reduced to a predetermined range.

Further, the conductive area that is eliminated may be formed in a diamond shape or a rectangular shape.

Further, the first and second transmission lines may be formed at a center cross section on the dielectric substrate and have a structure of a strip line with two ground planes.

Further, the center cross section may have one CPW crossing transmission line and another CPW crossing transmission line implemented thereon, and the another CPW crossing line is formed on one of the two ground planes.

Further, one surface of the dielectric substrate may have an RF transmission line implemented thereon, another surface has a DC (Direct Current) power/control line to be crossed at a certain region, the RF transmission line being formed to have a structure of a CPW (Coplanar Waveguide) transmission line at the crossing region.

In accordance with an embodiment of the present invention, two independent first and second microstrip transmission lines are formed on the same surface to cross with each other, and the crossing region of the first and the second microstrip transmission lines are formed on different surfaces, wherein a first microstrip transmission line extends from a first surface, and a second microstrip transmission line runs to a second surface from the first surface through a via-hole connection structure and is out of the crossing region to connect to the first surface again through the via-hole connection structure, and a structure of CPW transmission line is formed on the crossing region, thereby achieving a superior signal transmission property.

Further, in accordance with the crossover structure of the embodiment of the present invention, it is possible to reduce the size of the RF crossover circuit significantly and enhance the electrical properties such as an excellent input/output matching, an isolation characteristic between the transmission lines and a low insertion loss in microwave circuits to need RF crossover elements such as the Butler matrix for the multi-beam formation.

### BRIEF DESCRIPTION OF THE DRAWINGS

The above and other objects and features of the present invention will become apparent from the following description of the embodiments given in conjunction with the accompanying drawings, in which:

FIGS. 1A, 1B and 1C are exemplary diagrams of conventional RF crossover structures;

FIGS. 2A to 2D are exemplary diagrams that are implemented on a double-sided substrate in accordance with a first embodiment of the present invention;

FIG. 3 shows a structure of a co-planner waveguide transmission line in accordance with an embodiment of the present invention;

FIGS. 4A to 4D illustrate RF crossover structures with an improved isolation property in accordance with a second embodiment of the present invention;

FIGS. 5A and 5B depict shapes of conductive area that is eliminated in order to enhance an isolation characteristic in accordance with an embodiment of the present invention;

FIGS. 6A to 6D illustrate examples of design parameters and design values of the RF crossover in accordance with an embodiment of the present invention;

FIGS. 7 and 8 depict graphs of the experimental results of S-parameters of the RF crossover structures in accordance with the embodiments of the present invention;

FIG. 9 illustrates a graph comparing the isolation characteristic of RF crossover structures in accordance with embodiments of the present invention; and

FIGS. 10A and 10B illustrate a structure of the RF crossover between an RF transmission line and DC power/control lines in accordance with a third embodiment of the present invention.

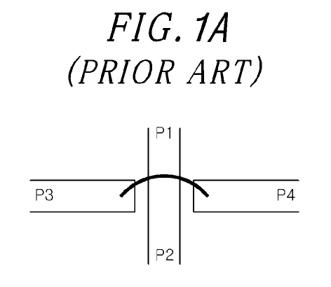

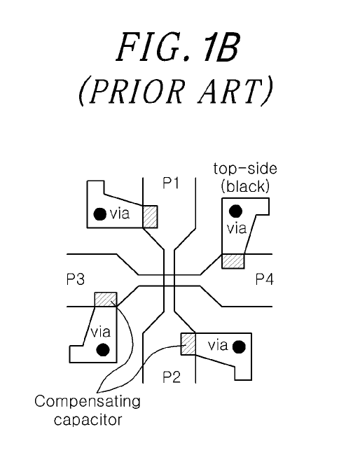

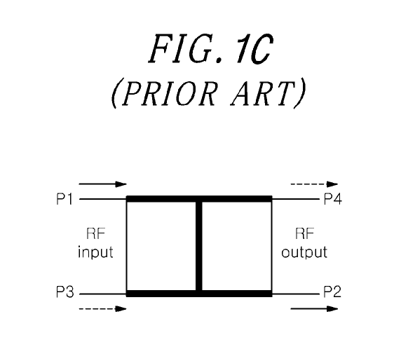

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, the embodiments of the present invention will be described in detail with reference to the accompanying drawings which form a part hereof.

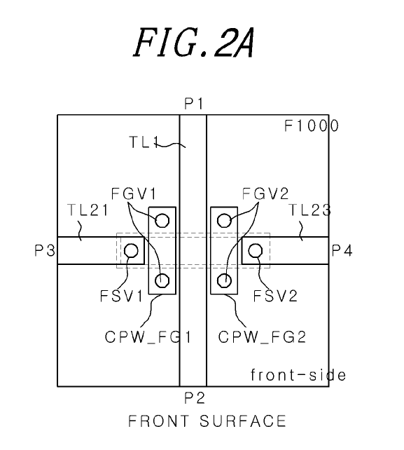

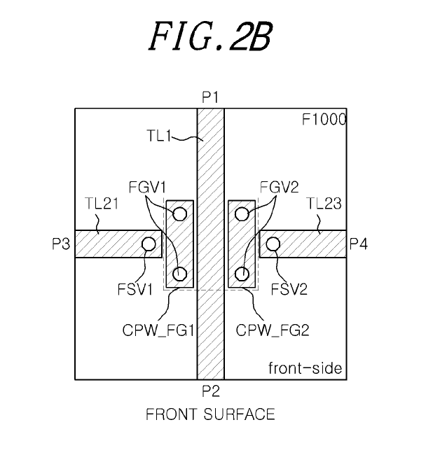

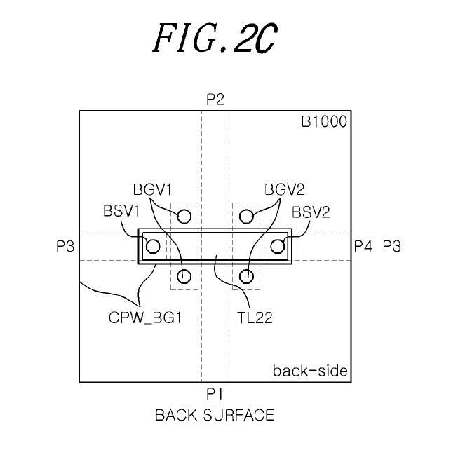

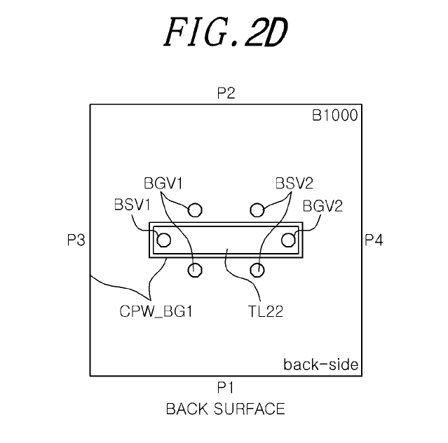

FIGS. 2A to 2D illustrate an RF crossover structure that minimizes the change in input/output characteristic impedances at a crossing region in accordance with a first embodiment of the present invention.

An RF crossover has a structure in which two independent transmission lines intersect perpendicularly with each other. In the RF crossover, the change in the input/output characteristic impedances should be minimized at the crossing region to each other, and an isolation characteristic should be superior so that there is no mutual coupling between the transmission lines. If these two conditions are satisfied, it is possible to design an RF crossover with a low insertion loss, an input/output matching characteristic and an excellent isolation property.

Referring to FIGS. 2A to 2D, both surfaces of a dielectric substrate are used, one side of the substrate is used as a region in which two perpendicular transmission lines enter and exit, the other side is used as a ground plane of the transmission lines and as a connection region to avoid direct crossing between the transmission lines.

The RF crossover structure proposed by the embodiment of the present invention includes a front surface F1000 that has input and output terminals P1 and P2, and a transmission line TL1 thereon. The front surface further includes a region which changes from a microstrip transmission line to coplanar waveguide line to compensate the characteristic impedance due to deformation of the ground plane of the transmission line TL1 by the transmission line TL22 that occurred in the crossing region. In other words, the region for compensation is composed of the transmission lines CPW_FG1 and CPW_FG2 that are used for a signal ground of the crossing region of the transmission line TL1, and two pairs of via-holes FGV1, FGV2 that are located at both ends of the transmission line CPW_FG1, CPW_FG2 in order to make the connection of the transmission lines CPW_FG1, CPW_FG2 with a lower ground plane.

Further, the transmission line TL1 the transmission line TL22 are formed at a center cross section on the dielectric substrate, and they have a structure of a strip line with two ground planes.

The via-holes FGV1, FGV2 presented on the front surface F1000 of the RF crossover are respectively connected to via-holes BGV1, BGV2 presented on the back surface B1000. Therefore, the signal input to the input terminal P1 is transferred to the output terminal P2 via the microstrip transmission line region, the coplanar waveguide line (crossing region) and the microstrip transmission line region. In this regard, the RF crossover is a reversible circuit, and thus the input and output terminals P1 and P2 may be changed in reverse.

Further, the RF crossover structure includes input and output terminals P3, P4 and the transmission line TL21 on the front surface F1000 that are independent and located in a direction perpendicular to each other to the input and output terminal P1, P2 and the transmission line TL1. In addition, the RF crossover structure includes the transmission line TL22 and a crossing region located on the back surface B1000 thereof. Moreover, in order to compensate the characteristic impedance of the transmission line TL22 considering the mutual coupling, which is occurred in the crossing region, due to the transmission lines TL1, CPW_FG1, CPW_FG2, the RF crossover structure further includes a region to change from the microstrip transmission lines to the coplanar waveguide lines, i.e., a ground plane CPW_BG1 on the back surface B1000 to be used for a signal ground provision of the crossing region of the transmission line TL22.

In addition, the RF crossover structure further includes a via-hole FSV1, which allows connecting the transmission lines TL21 and TL22, and a via-hole FSV2, which allows connecting the transmission lines TL22 and TL23. The via-holes FSV1, FSV2 presented on the front surface F100 of the RF crossover are connected to the via-holes BSV1, BSV2 presented on the back surface B100, respectively. In this regard, in order to isolate the ground plane from the transmission line TL22 connected to the back surface through the via-holes FSV1, FSV2, and in order to form a coplanar waveguide line structure with the same characteristic impedance as the input and output characteristic impedance, the optimal rectangular slot-loop is formed around the transmission line TL22.

Accordingly, the signal input to the input terminal P3 is transferred to the output terminal P4 through the microstrip transmission line region, the coplanar waveguide line (crossing region), and the microstrip transmission line region again. In relation to this, the RF crossover is a reversible circuit, and thus the input and output terminals P3 and P4 may be changed in reverse.

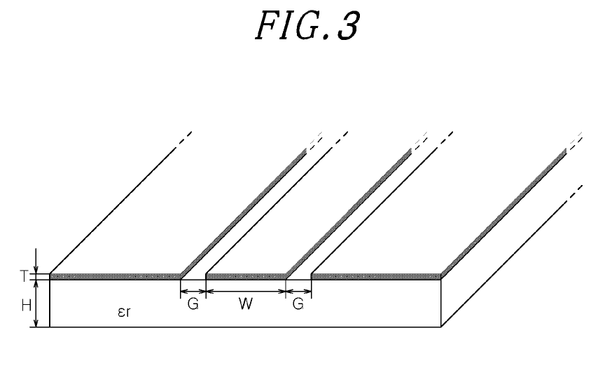

Meanwhile, a basic coplanar waveguide line as shown in FIG. 3 may be used so that the characteristic impedance of the coplanar waveguide transmission lines (i.e., TL1 and CPW_FG1, CPW-FG2 regions, and TL22 and CPW_BG regions) that are used in the crossing region maintains the same as the input/output characteristic impedances.

Further, the structure of the basic coplanar waveguide line as shown in FIG. 3 may be optimally designed using following Equations 1 to 4. The line width and the gap between the line width and the ground plane should be adjusted to maintain the characteristic impedance of the coplanar waveguide line as a specific value (in this example, 50 W). Among them, the gap greatly influences on the characteristic impedance. At this time, the design of the coplanar waveguide line needs also to take into account the layout pattern shape that is placed on the opposite side.

$$\begin{matrix}{Z}_{o} = \frac{30 π}{\sqrt{{ɛ}_{e}}} \frac{π ( {k}^{′} )}{K ( k )} & [ Equation 1 ] \\ {ɛ}_{e} = 1 + \frac{{ɛ}_{r} - 1}{2} \frac{K ( {k}^{′} ) K ( {k}_{1} )}{K ( k ) K ( {k}_{1}^{′} )} & [ Equation 2 ] \\ \frac{K ( k )}{{K}^{′} ( k )} = \{ \begin{matrix}{[ \frac{1}{π} ln ( 2 \frac{1 + \sqrt{{k}^{′}}}{1 - \sqrt{{k}^{′}}} ) ]}^{- 1} & for 0 \leq k \leq 0.7 \\ \frac{1}{π} ln ( 2 \frac{1 + \sqrt{k}}{1 - \sqrt{k}} ) & for 0.7 \leq k \leq 1\end{matrix} & [ Equation 3 ] \\ k = \frac{A}{B} , A = \frac{W}{2} , B = \frac{W}{2} + G , {k}_{1} = \frac{sinh ( 0.5 π AH )}{sinh ( 0.5 π BH )} & [ Equation 4 ]\end{matrix}$$

where K′(k)=K(k′), k′=\sqrt{1−k²}, εₑ denotes an effective dielectric constant, a function K represents a perfect primary elliptical function, K′ represents a complementary function of the function K.

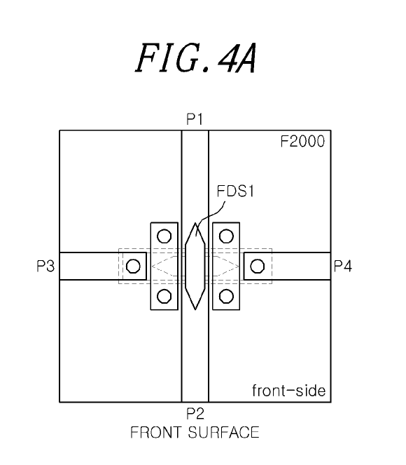

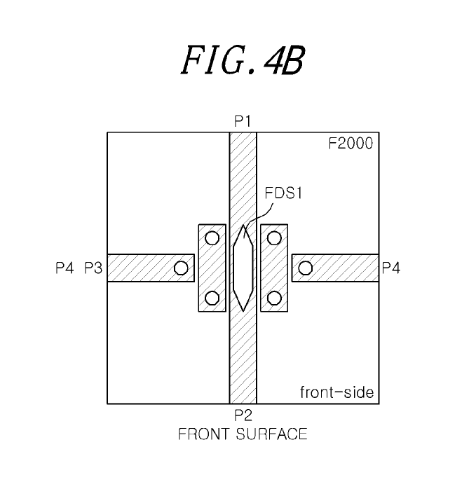

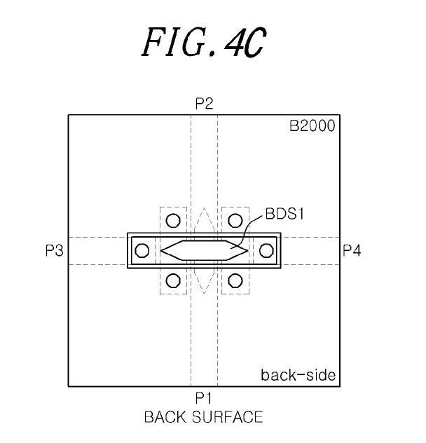

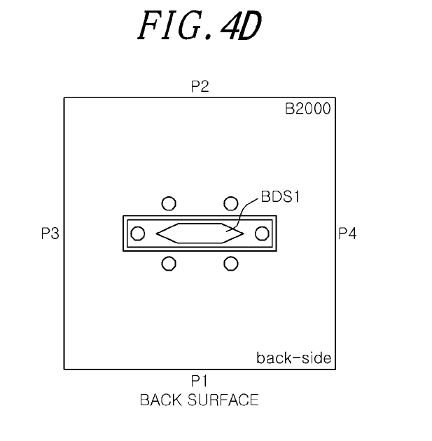

As shown in FIGS. 4A to 4D, a second embodiment of the present invention proposes an RF crossover structure with both surfaces F2000/B2000 in order to improve the isolation characteristic of the RF crossover structure with the both surfaces F1000/B1000. This RF crossover structure minimizes a signal coupling region (i.e., a signal coupling capacitance) of transmission lines TL1 and TL22 perpendicular each other in different surfaces and increases the thickness of the dielectric, thereby enhancing the isolation characteristic between the crossing two transmission lines.

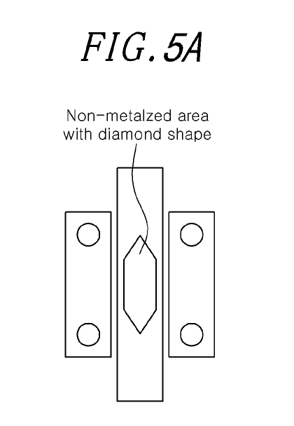

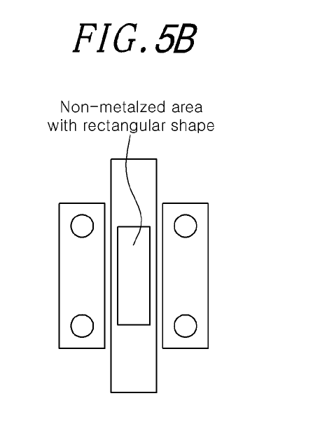

Further, when a conductive area in the crossing region is eliminated in order to minimize the signal coupling region, a non-metalized area at the center of the transmission lines TL1, TL22 may be formed in any shape such as a diamond shape and a rectangular shape as shown in FIGS. 5A and 5B, respectively.

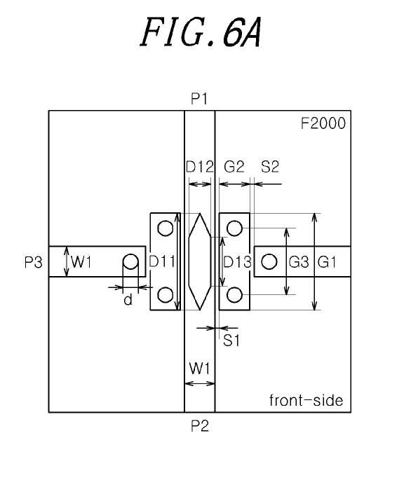

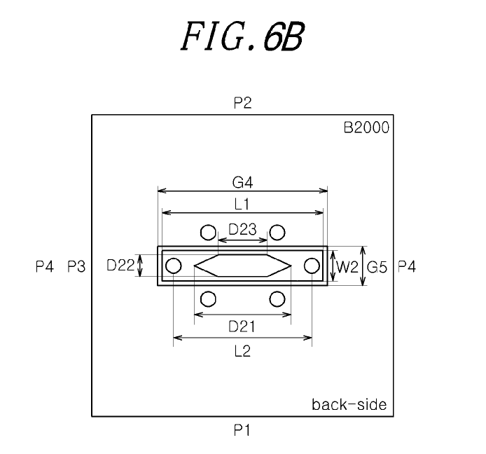

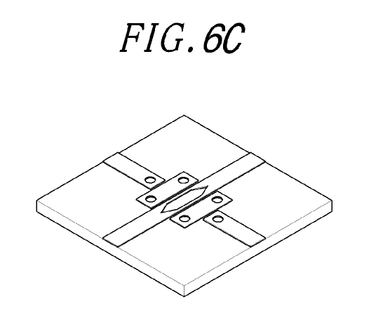

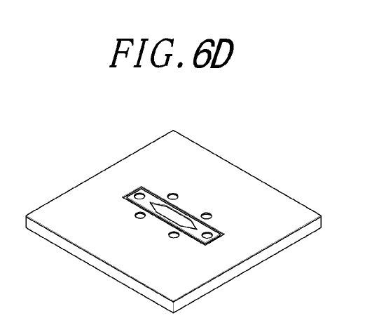

As an example, the planar RF crossover structure proposed by the embodiment of the present invention was designed using the design simulator (CST Microwave Studio commercially available) in order to check the electrical characteristics thereof. A dielectric substrate used in this design was a TLY-5A substrate commercially available from Taconic Inc., with a dielectric constant εᵣ=2.17, a thickness of the dielectric H=0.508 mm (20 mils). A thickness of the copper foil T=0.035 mm (1 oz.), and design parameters and design values for the RF crossover designed by an example are represented in FIGS. 6A to 6D.

Referring to FIGS. 6A to 6D, the design parameters and the design values for the RF crossover structure presented in accordance with an embodiment are as follows.

On the front surface F2000 shown in FIG. 6A, W₁=1.56 mm, S₁=0.15 mm, S₂=0.20 mm, D₁₁=4.00 mm, D₁₂=1.00 mm, D₁₃=2.00 mm, G₁=3.71 mm, G₂=1.00 mm, G₃=2.71 mm, d=0.55 mm.

On the back surface B2000 shown in FIG. 6B, W₂=1.40 mm, L₁=6.26 mm, L₂=5.26 mm, G₄=6.66 mm, G₅=1.71 mm, D₂₁=3.56 mm, D₂₂=1.00 mm, and D₂₃=1.56 mm.

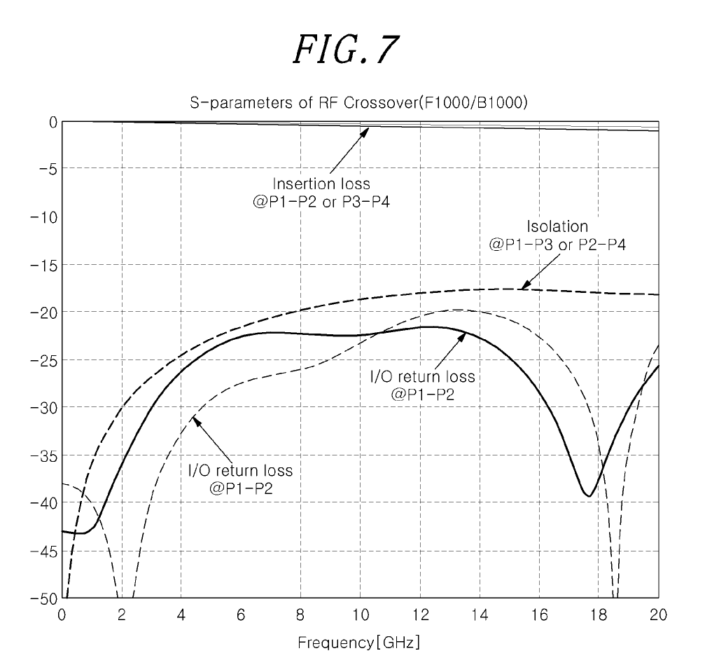

The RF crossover structure of the first embodiment of the present invention has the same design parameters and values as shown in FIGS. 6A to 6D except that it does not have the non-metalized area with the diamond shape, and its S-parameter simulation result is shown in FIG. 7.

That is, FIG. 7 shows the S-parameter simulation result of the RF crossover structure with the front and back surfaces F1000/B1000 in accordance with the first embodiment of the present invention.

As shown in FIG. 7, the RF crossover structure of the first embodiment of the present invention exhibits good electrical characteristics that an insertion loss in the broadband of 0˜20 GHz is 0.8 dB or less, an input/output matching characteristic is 19.8 dB or more, and an isolation characteristic is 17.7 dB or more.

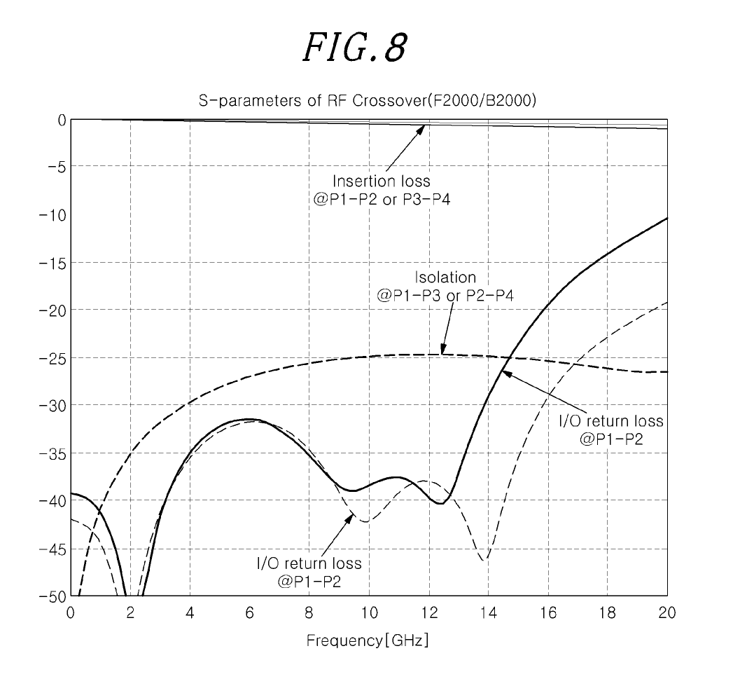

Further, the design parameters and the design values shown in FIG. 6 are also entirely kept in the RF crossover structure with the front and back surfaces F2000/B2000 in accordance with the second embodiment of the present invention and an S-parameter simulation result of the RF crossover of the second embodiment is represented in FIG. 8.

As shown in FIG. 8, the RF crossover structure of the second embodiment exhibits the phenomenon that the operating bandwidth is reduced slightly due to deterioration of the input/output matching characteristic, but this may be caused by a change in the characteristic impedance of the transmission lines and may be improved through optimization of a design process. The RF crossover, which is designed as one example, has an optimization frequency band of 0˜16 GHz and shows excellent electrical characteristics that an insertion loss in the operating frequency band is 0.45 dB or less, an input/output matching characteristic is 19.8 dB or more, and an isolation characteristic is 24.8 dB or more.

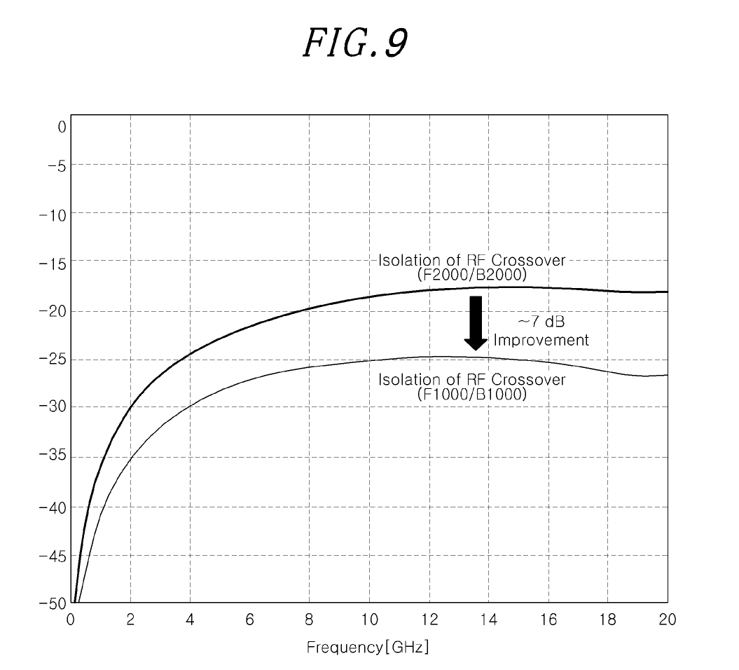

FIG. 9 is a graph comparing the isolation performances of the RF crossover structures with or without the non-metalized area at the center portion of the conductive area in the crossing region of the transmission lines.

That is, FIG. 9 shows the comparison result of the isolation characteristic between the RF crossover structures wherein the RF crossover structure of the first embodiment has not the non-metalized area within the crossing region of the transmission lines and the RF crossover configuration of the second embodiment has the non-metalized area within the crossing region of the transmission lines. In the RF crossover in which the conductive area is eliminated in the diamond shape, it is observed that there is an improvement of about 7 dB in the frequency band of 0˜20 GHz.

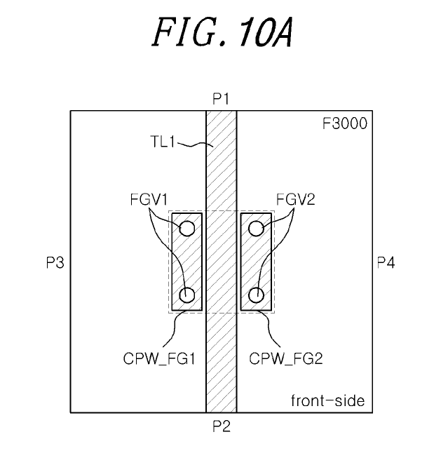

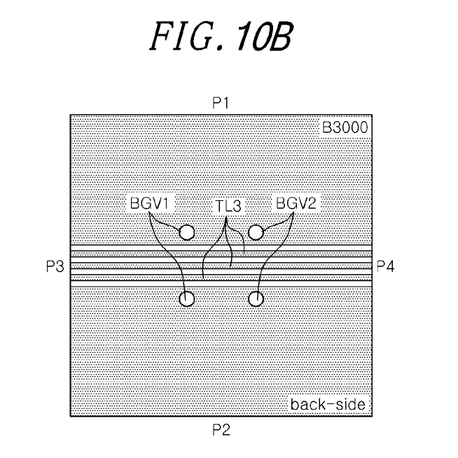

FIGS. 10A and 10B illustrate a crossover structure formed between an RF transmission line and DC power/control lines in accordance with a third embodiment of the present invention.

Referring to FIGS. 10A and 10B, the RF crossover structure has a configuration that an RF transmission line F3000 on a front surface of a dielectric substrate intersects with DC power/control lines B3000 on a back surface of a dielectric substrate within a predetermined region.

In order to compensate an electrical characteristic of the RF transmission line at a crossing region, i.e., in order to compensate input/output characteristic impedances, the RF crossover structure, as the same manner as described in FIGS. 2A to 2D, includes a region that changes from a microstrip line to a coplanar waveguide line. In other words, the region is composed of transmission lines CPW_FG1, CPW_FG2 that are used for a signal ground of the crossing region on the transmission line TL1 and two pairs of via-holes FGV1, FGV2 that are located at both ends of the transmission lines CPW_FG1, CPW_FG2 so that the transmission lines CPW_FG1, CPW_FG2 can be connected to a ground plane on the back surface.

The via-holes FGV1, FGV2 presented on the front surface F3000 of the RF crossover are respectively connected to the via-holes BGV1, BGV2 presented on the back surface B3000 of the RF crossover. Therefore, the signal input to the input terminal P1 is transferred to the output terminal P2 via the microstrip transmission line region, the coplanar waveguide line (crossing region), and the microstrip transmission line region again. In this regard, the RF crossover is a reversible circuit, and thus the input/output terminals P1 and P2 may be changed in reverse.

As described above, in accordance with an embodiment of the present invention, two independent first and second transmission lines are crossed each other and the crossing region of the first and the second transmission lines are formed on different surfaces, wherein a first transmission line extends from a first surface, and a second transmission line runs to a second surface from the first surface through a via-hole connection structure and is out of the crossing region to connect to the first surface again through the via-hole connection structure, and a structure of CPW transmission line is formed on the crossing region to achieve an optimal signal transmission property.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An RF crossover structure comprising:
a first and second independent transmission lines formed to cross with each other on a same surface of a dielectric substrate;
first via-holes connected to the second transmission line so that the second transmission line is connected to a back surface from a front surface of the dielectric substrate and is connected again to the front surface of the dielectric substrate out of a crossing region at which the first and the second transmission lines are crossed; and
CPW (Coplanar Waveguide) transmission lines used for a ground plane to improve a signal transmission property at the crossing region.

2. The RF crossover structure of claim 1, further comprising second via-holes that connect the CPW transmission line to a ground plane on the back surface of the dielectric substrate.

3. The RF crossover structure of claim 2, wherein the CPW transmission lines are configured to compensate the signal transmission property due to a mutual coupling at the crossing region between the first and second transmission lines.

4. The RF crossover structure of claim 3, wherein the signal transmission property comprises an input/out matching characteristic or change in impedance.

5. The RF crossover structure of claim 1, wherein the CPW transmission lines are configured to have the same impedance characteristic as the input/output characteristic impedances in order to isolate the second transmission line that is connected to the back surface of the dielectric substrate through the structure of the via-holes from the ground plane.

6. The RF crossover structure of claim 1, further comprising:
a slot-loop formed in the form of a rectangle in the vicinity of the second transmission line on the back surface of the dielectric substrate in order to improve a signal transmission property.

7. The RF crossover structure of claim 1, wherein the first and second transmission lines have a conductive area of which a portion is eliminated in a certain form so that a signal coupling region is set to be a predetermined area and the signal coupling region of the first and second transmission lines that are perpendicular to each other on different surfaces of the dielectric substrate is reduced to a predetermined range.

8. The RF crossover structure of claim 7, wherein the conductive area that is eliminated is formed in a diamond shape or a rectangular shape.

9. The RF crossover structure of claim 1, wherein the first and second transmission lines are formed at a center cross section on the dielectric substrate, and wherein the first and second transmission lines have a structure of a strip line with two ground planes.

10. The RF crossover structure of claim 9, wherein the center cross section has one CPW crossing transmission line, and another CPW crossing transmission line implemented thereon, wherein the another CPW crossing line is formed on one of the two ground planes.

11. An RF crossover structure comprising:
an RF transmission line formed on a first surface of a dielectric substrate; and
DC power/control lines formed on a second surface of the dielectric substrate to cross with the RF transmission line at a crossing region,
wherein the RF transmission line is formed to have a structure of a CPW (Coplanar Waveguide) transmission line at the crossing region.
